(19) United States
(12) Patent Application Publication
(10) Pub. No.: US 2024/0048334 A1
(43) Pub. Date: Feb. 8, 2024

(54) METHOD AND APPARATUS FOR BANDWIDTH ADAPTIVE SCHEDULING IN CLOUD BASED VIRTUAL NETWORK FUNCTIONS FOR TRAFFIC OVER POINT-TO-POINT OVERLAY TUNNELS

(71) Applicant: CradlePoint, Inc., Boise, ID (US)

(72) Inventors: Natarajan Venkataraman, Boise, ID (US); Prashant Pai, Los Gatos, CA (US)

(73) Assignee: CradlePoint, Inc., Boise, ID (US)

(21) Appl. No.: 17/816,896

(22) Filed: Aug. 2, 2022

(51) Int. Cl. H04L 5/00; H04W 28/10

(52) U.S. Cl. CPC H04L 5/0055; H04W 28/10

(57) ABSTRACT

Disclosed embodiments include computer-based adaptive schedulers, and methods for operating, for adaptively scheduling the flow of packets in a network, the adaptive scheduler including a queue communication module communicating with a queue of packets queued to be sent over the network, an ACK packet receiver module communicating with an ACK packet receiver and receiving information related to the number of ACK packets received by the ACK packet receiver, a transmit window module communicating with a packet transmitter and receiving information related to the number of bytes that can be transmitted and sets a transmit window duration for a packet in the queue to be transmitted and schedules the transmission of the packet in the queue by the packet transmitter and, a time window module that adaptively sets a duration for which the ACK packet receiver module will wait for ACK packets to be received by the ACK packet receiver.

### FIELD OF THE DISCLOSURE

This disclosure relates generally to network function virtualization (NFV). More particularly, this disclosure relates to solutions for quality of service (QoS) in NFV where available bandwidth fluctuates.

### BACKGROUND

In recent years, NFV has been a major trend in the telecom/datacom industry. The trend towards NFV has resulted in many traditional network applications being run virtualized in the cloud (for public and private applications) as virtual network functions. The 5G standard for cellular networks has adopted many cloud-based technologies to implement the 5G nodes.

In a cloud-based virtual machine, the interface over which packets are sent to remote users are usually high-speed (e.g., 10G or 40G) interfaces. Such high-speed interfaces are unlikely to see packet buildup or backpressure. Thus, any traffic drops will likely not happen at the interface of the virtual machine, but somewhere “downstream” and remote where there is a bottleneck link or the like.

A challenge that any such node that handles data traffic, especially data traffic flowing towards an end-user mobile device, is that of fluctuating bandwidth in the over-air or wireless interface. In the face of fluctuating bandwidth, it is difficult for the cloud-based network function to provide any kind of QoS for the various types of network traffic.

Vendors who operate in a software-defined wide area network (SD-WAN) and/or zero trust network access (ZTNA) space face at least the above challenges. SD-WAN/ZTNA vendors typically use a cloud device to apply protocols for security, application-identification, etc., and handle data traffic, and it is difficult to provide QoS protocols. In fact, most such SD-WAN/ZTNA vendors are focused on QoS solutions meant for fixed wireline access, where the fluctuating bandwidth constraint typically does not apply.

For example, some vendors may provide bandwidth management techniques such as attaching a shaper to a P2P tunnel. However, this approach only works for scenarios where the remote bottleneck link bandwidth is constant, not in the mobile wireless air interface where the bandwidth is expected to fluctuate.

Other existing solutions include implementing a “bandwidth guessing” algorithm in the broad family of TCP congestion control algorithms. While they started with TCP, a stream-oriented protocol, they have been carried over to datagram-based protocols such as DCCP and alternate protocols to TCP such as QUIC. But all these protocols are end-to-end. They operate above the IP-layer, and they cannot operate at the IP-layer.

Therefore, there is a need in the SD-WAN/ZTNA space for solutions that can cater to QoS in the face of fluctuating bandwidth in the “last mile” of over-air or wireless access. Other needs, drawbacks, issues, and inconveniences with existing solutions also exist.

### SUMMARY

Accordingly, the herein disclosed systems and methods address the above-noted, and other, needs, drawbacks, issues, and inconveniences with existing solutions. Disclosed embodiments include computer-based adaptive schedulers for adaptively scheduling the flow of packets in a network, the adaptive scheduler including a set of computer-based instructions to cause a processor to carry out functions that include a queue communication module that communicates with a queue of packets queued to be sent over the network, an ACK packet receiver module that communicates with an ACK packet receiver on the network and receives information related to the number of ACK packets received by the ACK packet receiver, a transmit window module that communicates with a packet transmitter on the network and receives information related to the number of bytes that can be transmitted on the network and sets a transmit window duration for a packet in the queue to be transmitted on the network and schedules the transmission of the packet in the queue on the network by the packet transmitter and, a time window module that adaptively sets a duration for which the ACK packet receiver module will wait for ACK packets to be received by the ACK packet receiver.

Further disclosed embodiments of the adaptive scheduler include a transmit window module that is a deficit counter that returns either a positive or negative integer based on the information related to the number of bytes that can be transmitted on the network.

In further disclosed embodiments, the transmit window module is invoked to schedule a packet in the queue for transmission on the network by the packet transmitter when the deficit counter returns a positive integer.

In further disclosed embodiments, the transmit window duration is increased for each ACK packet received by the ACK packet receiver. In still further disclosed embodiments, the transmit window duration is increased by a discrete quantum for a first ACK packet received by the ACK packet receiver. In still further disclosed embodiments, the transmit window duration is increased by double the discrete quantum for a second ACK packet received by the ACK packet receiver.

In further disclosed embodiments, the transmit window duration is increased by a predetermined amount proportional to the amount of ACK packets received by the ACK packet receiver.

In further disclosed embodiments, the transmit window duration is decreased if a predetermined number of ACK packets are not received by the ACK packet receiver. In still further disclosed embodiments, the transmit window duration is decreased by a discrete quantum if a predetermined number of ACK packets are not received by the ACK packet receiver. In still further disclosed embodiments, the transmit window duration is decreased by an amount proportional to the number of ACK packets received by the ACK packet receiver.

Also disclosed are computer-based methods for adaptively scheduling the flow of packets in a network, the methods including a set of computer-based instructions to cause a processor to carry out functions that include communicating with a queue of packets queued to be sent over the network, communicating with an ACK packet receiver on the network to receive information related to the number of ACK packets received by the ACK packet receiver, communicating with a packet transmitter on the network to receive information related to the number of bytes that can be transmitted on the network, applying a transmit window duration and schedule to transmit packets on the network, and setting a time window based at least in part on whether all packets sent in a previous time window were acknowledged.

In further disclosed embodiments, the transmit window duration is set based on a deficit counter that returns either a positive or negative integer based on the information related to the number of bytes that can be transmitted on the network.

In further disclosed embodiments, the time window is set based at least in part on expected bandwidth rate. In still further disclosed embodiments, the transmit window duration is increased for each ACK packet received by the ACK packet receiver. In still further disclosed embodiments, the transmit window duration is increased by a discrete quantum for a first ACK packet received by the ACK packet receiver. In still further disclosed embodiments, the transmit window duration is increased by double the discrete quantum for a second ACK packet received by the ACK packet receiver. In still further disclosed embodiments, the transmit window duration is increased by a predetermined amount proportional to the amount of ACK packets received by the ACK packet receiver.

In further disclosed embodiments, the transmit window duration is decreased if a predetermined number of ACK packets are not received by the ACK packet receiver. In still further disclosed embodiments, the transmit window duration is decreased by a discrete quantum if a predetermined number of ACK packets are not received by the ACK packet receiver. In still further disclosed embodiments, the transmit window duration is decreased by an amount proportional to the number of ACK packets received by the ACK packet receiver. Other embodiments also exist.

### BRIEF DESCRIPTION OF THE DRAWINGS

FIG. 1 is a schematic illustration of a system for bandwidth adaptive scheduling in accordance with disclosed embodiments.

FIG. 2 is a schematic illustration of an adaptive scheduler module in accordance with disclosed embodiments.

FIG. 3 is an exemplary flow chart illustrating methods 300 of adaptively scheduling the flow of packets in a network in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

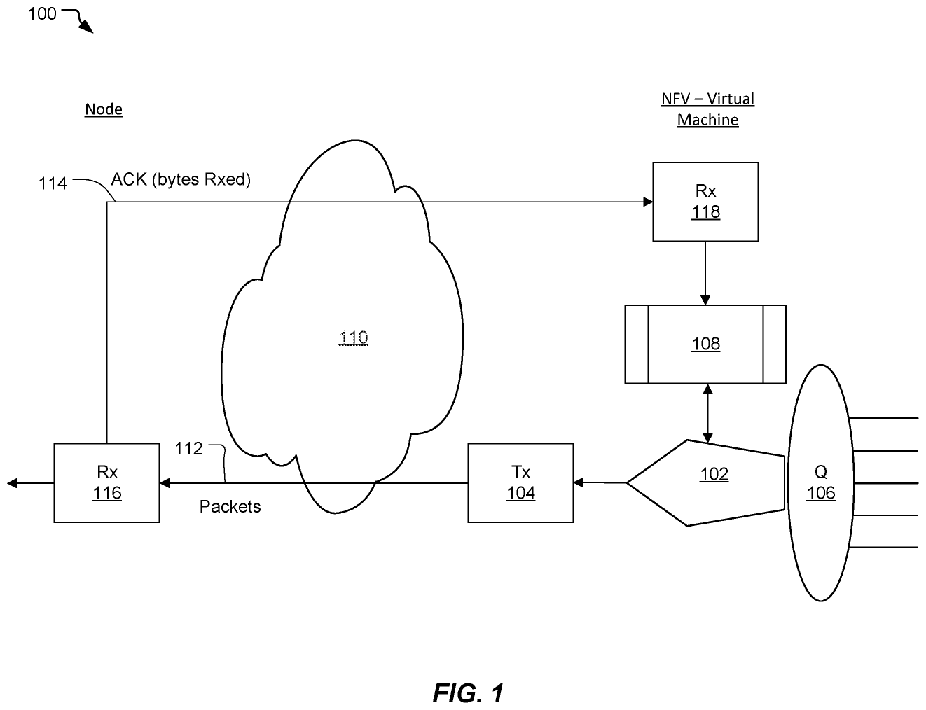

As disclosed herein embodiments of bandwidth adaptive schedulers function in the spirit of TCP congestion control algorithms, such as TCP-Reno, modified to operate at the IP layer. For example, FIG. 1 is a schematic illustration of a system 100 for bandwidth adaptive scheduling in accordance with disclosed embodiments. The system 100 shown in FIG. 1 implements a TCP congestion control algorithm similar to TCP-Reno, but those of ordinary skill in the art having the benefit of this disclosure would understand that other alternative TCP congestion control algorithms, such as TCP-Westwood, CUBIC, and the like, can be adapted in accordance with the principles of this disclosure.

As illustrated in FIG. 1, system 100 comprises two main elements, a virtual machine (VM) side (e.g., as provided by a SD-WAN/ZTNA vendor) and a network node side (e.g., a router or the like). In some embodiments, adaptive scheduler 102 runs algorithms on the NFV-VM transmitting node 104 and to which queues 106 are attached. Queues 106 may correspond to traffic classes such as, but not limited to, real-time class, interactive class, business-critical class, best effort class, control class, management class, and the like. Adaptive scheduler 102 implements a dynamic bandwidth detection scheme as disclosed herein and can be a modified TCP scheme such as TCP-Reno, CUBIC, or the like. Adaptive scheduler 102 communicates its adaptive scheduler state 108 as illustrated schematically.

As shown schematically, packets 112 are communicated from transmitting node 104 over network 110 which may comprise a mobile (e.g., cellular) network 110. As also indicated, an ACK packet 114 generated by the remote receiving node 116 and sent ultimately to the transmitting node 104, containing the bytes received (since the last sent ACK packet 114). ACK packets 114 are special types of packets 112 sent by the remote receiver node 116 at a high priority. In some embodiments, ACK packets 114 can consolidate bytes received across multiple packets 112 of a burst that are not delayed too much. In some embodiments the ACK information may be piggybacked onto a packet 112 that is sent from the node side to the NFV side. Other configurations are also possible. In general, ACK packets 114 do not have a sequence number and are typically not retransmitted.

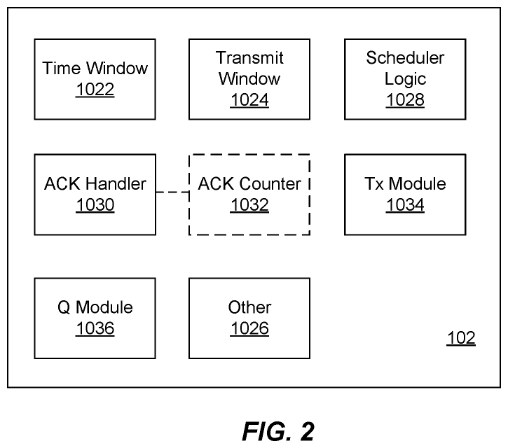

As shown schematically, an ACK receiver 118 at the transmitting VM node, feeds back the received information (bytes received) to the adaptive scheduler 102. As shown schematically in FIG. 2, the adaptive scheduler 102 maintains a “time window” 1022 and a “transmit window” 1024. As also indicated adaptive scheduler 102 may include other modules 1026 and algorithms as would be appreciated by persons of ordinary skill having the benefit of this disclosure.

The transmit window 1024 is a count of the bytes that can be transmitted. In some embodiments the byte count is treated as a “deficit” counter, which means, so long as the transmit window 1024 is non-zero, a packet can be scheduled to transmit. Thus, transmit window 1024 is a signed (e.g., “positive” or “negative”) integer. If the transmit window 1024 is positive, the adaptive scheduler 102 is invoked to pick a packet 112 from the queue 106 to transmit.

The time window 1022 is a duration for which the transmitter 104 will await ACK packets 114 for bytes sent towards the receiver 116. Each ACK packet 114 will result in increase of the transmit window 1024. If, at the end of the time window 1022, all the bytes sent during the window are not acknowledged, then the transmit window 1024 is reduced for the next time window 1022. In other words, and as a non-limiting example, a given transmit window 1024 is of a given size at the start of a first time window 1022. The ACK packets 114 received during that first time window 1022 are counted (by ACK counter 1032) and reconciled to determine whether the size of the next (second) time window 1022 should be increased or decreased to accommodate more or less packets 112 respectively. Other embodiments and configurations are also possible.

For example, for embodiments implementing a TCP-Reno-like algorithm, for each ACK packet 114 received, the transmit window 1024 may be incremented by a discrete quantum and the quantum may be doubled to increment for the next ACK packet 114 (like in TCP-Reno), or the transmit window 1024 may be increased by a predetermined proportion related to the amount of ACK packets 114 received. Likewise, for each time window 1022 for which all bytes are not acknowledged, the transmit window 1024 may be reduced by half (like in TCP-Reno), or by the latest quantum amount. At the start of each time window 1022 the quantum being used may be reset to an initial value.

As also indicated schematically, embodiments of adaptive scheduler 102 may also include modules and algorithms (i.e., software, firmware, and the like) for the herein disclosed adaptive schedule logic 1028, an ACK packet handler 1030 that, among other things, enables communication between ACK receiver 118 and adaptive scheduler 102, and an ACK packet counter 1032. As indicated schematically, ACK counter 1032 may be a component of ACK handler 1030, a separate module, may be a component of ACK receiver 118, or the like. Embodiments of adaptive scheduler 102 may also include transmitter modules 1034 for communications with transmitting node 104 and Q module 1036 for communications with queues 106. Other modules are also possible.

Disclosed embodiments also have some differences from existing TCP congestion control implementations, such as the herein disclosed embodiments do not account for duplicate ACK packets 114 because that does not suit operation in the IP-layer where packets 112 do not maintain any sequence number. Likewise, herein disclosed embodiments just send the transmitted packet 112 as it usually is usually sent, there is no sequence number added. Further, the ACK packets 114 from the receiver 116 could be separate packets or added as a trailer to data packets sent towards the sender at receiver 118 (and sender is expected to remove the trailer). Finally, while TCP-Reno was chosen for the exemplary illustrations herein due to its simplicity, alternative algorithms like CUBIC and the like can be equally well adapted, using the framework described here.

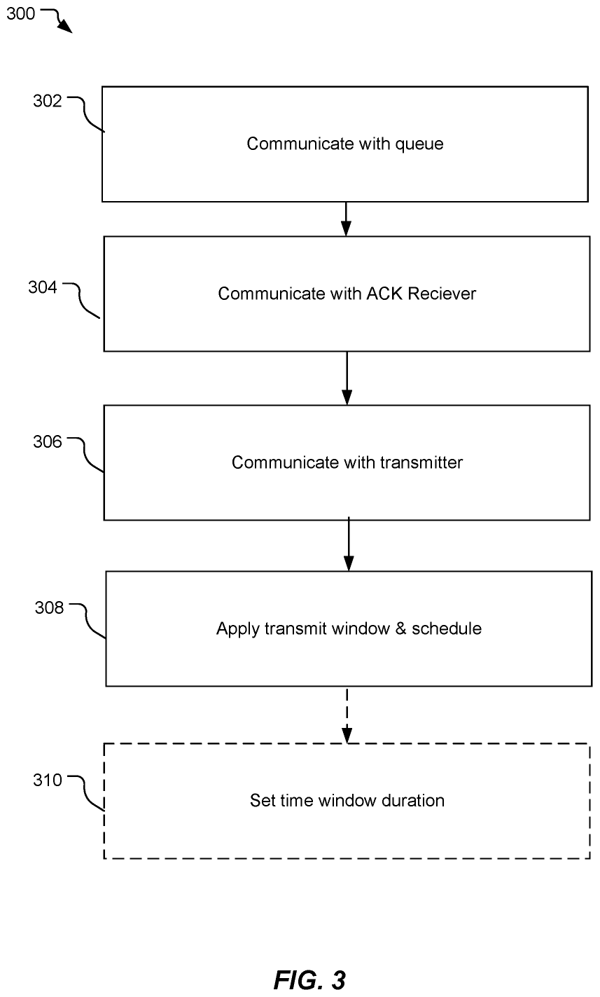

FIG. 3 is an exemplary flow chart illustrating methods 300 of adaptively scheduling the flow of packets in a network in accordance with disclosed embodiments. As illustrated, method 300 may include Q module 1036 communicating at 302 with a queue of packets (e.g., queue 106) queued to be sent over the network 110. At 304, communicating with an ACK packet receiver 118 on the network 110 to receive information related to the number of ACK packets 114 received by the ACK packet receiver 118. This information may be compiled and communicated via ACK handler 1030 and ACK counter 1032.

Embodiments of method 300 also include, at 306, communicating with a packet transmitter 104 on the network 110 to receive information related to the number of bytes that can be transmitted on the network 110. In some embodiments communication 306 may occur via transmit module 1034 checking the network 110 interface to determine readiness to accept packet(s) 112 for sending over the network 110 interface. Based on that communication, transmit module 1034 will indicate to adaptive scheduler 102 to provide packet(s) 112 for transmission. At 308, applying the transmit window 1024 duration and schedule to transmit the packet in the queue 106 on the network 110 by the packet transmitter 104. As disclosed herein, the transmit window 1024 is a variable maintained by the adaptive scheduler 102 that is either incremented, decremented, or set when required. Time window 1024 may be decremented when packets 112 are sent out and set to a value when starting a new time window 1022. The value to set will be based on whether all packets 112 sent in the previous time window 1022 were acknowledged or not (e.g., counted and reconciled by ACK handler 1030 and ACK counter 1032).

In some embodiments, time window 1024 may be a constant value, or as indicated at 310, may optionally be set to a time window 1022 duration for which the ACK packet receiver 118 will wait for ACK packets 114 to be received based, at least in part, on expected bandwidth rate or the like. Other embodiments also exist.

Although various embodiments have been shown and described, the present disclosure is not so limited and will be understood to include all such modifications and variations would be apparent to one skilled in the art.

What is claimed is:

1. A computer-based adaptive scheduler for adaptively scheduling the flow of packets in a network, the adaptive scheduler comprising a set of computer-based instructions to cause a processor to carry out functions comprising:
a queue communication module that communicates with a queue of packets queued to be sent over the network;
an ACK packet receiver module that communicates with an ACK packet receiver on the network and receives information related to the number of ACK packets received by the ACK packet receiver;
a transmit window module that communicates with a packet transmitter on the network and receives information related to the number of bytes that can be transmitted on the network and sets a transmit window duration for a packet in the queue to be transmitted on the network and schedules the transmission of the packet in the queue on the network by the packet transmitter; and
a time window module that adaptively sets a duration for which the ACK packet receiver module will wait for ACK packets to be received by the ACK packet receiver.

2. The computer-based adaptive scheduler of claim 1 wherein the transmit window module is a deficit counter that returns either a positive or negative integer based on the information related to the number of bytes that can be transmitted on the network.

3. The computer-based adaptive scheduler of claim 2 wherein the transmit window module is invoked to schedule a packet in the queue for transmission on the network by the packet transmitter when the deficit counter returns a positive integer.

4. The computer-based adaptive scheduler of claim 1 wherein the transmit window duration is increased for each ACK packet received by the ACK packet receiver.

5. The computer-based adaptive scheduler of claim 4 wherein the transmit window duration is increased by a discrete quantum for a first ACK packet received by the ACK packet receiver.

6. The computer-based adaptive scheduler of claim 5 wherein the transmit window duration is increased by double the discrete quantum for a second ACK packet received by the ACK packet receiver.

7. The computer-based adaptive scheduler of claim 4 wherein the transmit window duration is increased by a predetermined amount proportional to the amount of ACK packets received by the ACK packet receiver.

8. The computer-based adaptive scheduler of claim 1 wherein the transmit window duration is decreased if a predetermined number of ACK packets are not received by the ACK packet receiver.

9. The computer-based adaptive scheduler of claim 8 wherein the transmit window duration is decreased by a discrete quantum if a predetermined number of ACK packets are not received by the ACK packet receiver.

10. The computer-based adaptive scheduler of claim 8 wherein the transmit window duration is decreased by an amount proportional to the number of ACK packets received by the ACK packet receiver.

11. A computer-based method for adaptively scheduling the flow of packets in a network, the method comprising a set of computer-based instructions to cause a processor to carry out functions comprising:
communicating with a queue of packets queued to be sent over the network;
communicating with an ACK packet receiver on the network to receive information related to the number of ACK packets received by the ACK packet receiver;
communicating with a packet transmitter on the network to receive information related to the number of bytes that can be transmitted on the network;
applying a transmit window duration and schedule to transmit packets on the network; and
setting a time window based at least in part on whether all packets sent in a previous time window were acknowledged.

12. The computer-based method of claim 11 wherein the transmit window duration is set based on a deficit counter that returns either a positive or negative integer based on the information related to the number of bytes that can be transmitted on the network.

13. The computer-based method of claim 12 wherein the time window is set based at least in part on expected bandwidth rate.

14. The computer-based method of claim 11 wherein the transmit window duration is increased for each ACK packet received by the ACK packet receiver.

15. The computer-based method of claim 14 wherein the transmit window duration is increased by a discrete quantum for a first ACK packet received by the ACK packet receiver.

16. The computer-based method of claim 15 wherein the transmit window duration is increased by double the discrete quantum for a second ACK packet received by the ACK packet receiver.

17. The computer-based method of claim 14 wherein the transmit window duration is increased by a predetermined amount proportional to the amount of ACK packets received by the ACK packet receiver.

18. The computer-based method of claim 11 wherein the transmit window duration is decreased if a predetermined number of ACK packets are not received by the ACK packet receiver.

19. The computer-based method of claim 18 wherein the transmit window duration is decreased by a discrete quantum if a predetermined number of ACK packets are not received by the ACK packet receiver.

20. The computer-based method of claim 18 wherein the transmit window duration is decreased by an amount proportional to the number of ACK packets received by the ACK packet receiver.
